(19) United States
(12) Patent Application Publication
(10) Pub. No.: US 2025/0225440 A1
(43) Pub. Date: Jul. 10, 2025

(54) SYSTEM AND METHOD FOR UPDATING MACHINE-LEARNING MODELS

(71) Applicant: Arta Tech Pte. Ltd., Singapore (SG)

(72) Inventors: Chirag Yagnik, Mountain View, CA (US); Riccardo Turchetto, Mountain View, CA (US); Caesar Sengupta, Singapore (SG); Venkat Rapaka, Mountain View, CA (US)

(21) Appl. No.: 19/012,079

(22) Filed: Jan. 7, 2025

Related U.S. Application Data
(60) Provisional application No. 63/618,678, filed on Jan. 8, 2024.

(51) Int. Cl. G06N 20/00; G06Q 40/06

(52) U.S. Cl. CPC G06N 20/00; G06Q 40/06

(57) ABSTRACT

In an embodiment, a method includes receiving a query specifying a request for a recommendation of an asset portfolio, identifying a set of digitally stored documents for use in re-training a trained machine-learning model capable of outputting a recommendation of a particular asset portfolio, generating and storing in memory of the first computer document segments for each document of the set of documents, determining at least a theme and a theme-specific summary for each document segment among the document segments, generating document embeddings for the document segments of each document of the set of documents, the document embedding for each document segment embedding the theme, and the theme-specific summary associated with that document segment, re-training the trained machine-learning model based on the document embeddings to produce a re-trained machine-learning model, and executing an inference stage of the re-trained machine-learning model over the query to cause outputting a recommended asset portfolio.

### CROSS-REFERENCE TO RELATED APPLICATIONS

This application claims the benefit under 35 U.S.C. § 119(e) of provisional application 63/618,678, filed Jan. 8, 2024, the entire contents of which are hereby incorporated by reference for all purposes as if fully set forth herein.

### COPYRIGHT NOTICE

A portion of this patent document's disclosure contains material subject to copyright protection. The copyright owner has no objection to the facsimile reproduction by anyone of the patent document or the patent disclosure, as it appears in the Patent and Trademark Office patent file or records, but otherwise reserves all copyright or rights. @2022-2023 Arta Finance, Inc.

### TECHNICAL FIELD

One technical field of the present disclosure is the computer-implemented updating of machine-learning models.

### BACKGROUND

The approaches described in this section are approaches that could be pursued but not necessarily approaches that have been previously conceived or pursued. Therefore, unless otherwise indicated, it should not be assumed that any of the approaches described in this section qualify as prior art merely by their inclusion in this section.

Updating a machine-learning model, also known as “model retraining,” involves feeding a deployed model with new data to adapt its predictions to current conditions, improving its accuracy by incorporating recent information and trends within the data landscape. Updating a machine-learning model can be done manually or automated as part of a continuous monitoring process to ensure optimal performance over time.

### SUMMARY

The appended claims may serve as a summary of the invention.

### BRIEF DESCRIPTION OF THE DRAWINGS

In the drawings:

FIG. 1 illustrates an example of a computer-implemented method of updating a machine-learning model.

FIG. 2 illustrates an example of a computer-implemented method of processing data.

FIG. 3 illustrates an example method for finetuning a machine-learning model.

FIG. 4 illustrates an example method for updating the machine-learning model using processed data embeddings.

FIG. 5 illustrates another example method for updating the machine-learning model 315 using processed data embeddings.

FIG. 6 illustrates a computer system with which one embodiment could be implemented.

### DETAILED DESCRIPTION

### 1. General Overview

### 1.1 Terminology and Organization

In the following description, for the purposes of explanation, numerous specific details are set forth to provide a thorough understanding of the present invention. It will be apparent, however, that the present invention may be practiced without these specific details. In other instances, well-known structures and devices are shown in block diagram form to avoid unnecessarily obscuring the present invention.

The text of this disclosure, in combination with the drawing figures, is intended to state in prose the algorithms that are necessary to program the computer to implement the claimed inventions at the same level of detail that is used by people of skill in the arts to which this disclosure pertains to communicate with one another concerning functions to be programmed, inputs, transformations, outputs and other aspects of programming. That is, the level of detail outlined in this disclosure is the same level of detail that persons of skill in the art normally use to communicate with one another to express algorithms to be programmed or the structure and function of programs to implement the inventions claimed herein.

This disclosure may describe one or more different inventions, with alternative embodiments to illustrate examples. Other embodiments may be utilized, and structural, logical, software, electrical, and other changes may be made without departing from the scope of the particular inventions. Various modifications and alterations are possible and expected. Some features of one or more of the inventions may be described with reference to one or more particular embodiments or drawing figures, but such features are not limited to usage in the one or more particular embodiments or figures with reference to which they are described. Thus, the present disclosure is neither a literal description of all embodiments of one or more inventions nor a listing of features of one or more inventions that must be present in all embodiments.

Headings of sections and the title are provided for convenience but are not intended to limit the disclosure in any way or as a basis for interpreting the claims. Devices that are described as in communication with each other need not be in continuous communication with each other unless expressly specified otherwise. In addition, devices that communicate with each other may communicate directly or indirectly through one or more intermediaries, logical or physical.

A description of an embodiment with several components in communication with one other does not imply that all such components are required. Optional components may be described to illustrate a variety of possible embodiments and to fully illustrate one or more aspects of the inventions. Similarly, although process steps, method steps, algorithms, or the like may be described in sequential order, such processes, methods, and algorithms may generally be configured to work in different orders unless specifically stated to the contrary. Any sequence or order of steps described in this disclosure is not a required sequence or order. The steps of the described processes may be performed in any order practical. Further, some steps may be performed simultaneously. The illustration of a process in a drawing does not exclude variations and modifications, does not imply that the process or any of its steps are necessary to one or more of the invention(s), and does not imply that the illustrated process is preferred. The steps may be described once per embodiment but need not occur only once. Some steps may be omitted in some embodiments or occurrences, or some steps may be executed more than once in a given embodiment or occurrence. When a single device or article is described, more than one device or article may be used in place of a single device or article. Where more than one device or article is described, a single device or article may be used instead of more than one device or article.

The functionality or features of a device may be alternatively embodied by one or more other devices that are not explicitly described as having such functionality or features. Thus, other embodiments of one or more of the inventions need not include the device itself. Techniques and mechanisms described or referenced herein will sometimes be described in singular form for clarity. However, it should be noted that particular embodiments include multiple iterations of a technique or multiple manifestations of a mechanism unless noted otherwise. Process descriptions or blocks in figures should be understood as representing modules, segments, or portions of code that include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved.

### 1.2 Overview of Example Embodiments

Example embodiments encompass the subject matter of the following numbered clauses:

1. A computer-implemented method executed using a first computer and comprising: receiving, from a second computer, a query specifying a request for a recommendation of an asset portfolio; in response to receiving the query, identifying a set of digitally stored documents for use in re-training a trained machine-learning model capable of outputting a recommendation of a particular asset portfolio; generating and storing in memory of the first computer a plurality of document segments for each document of the set of documents; determining at least a theme and a theme-specific summary for each document segment among the plurality of document segments; generating a plurality of document embeddings for the plurality of document segments of each document of the set of documents, the document embedding for each document segment embedding the theme, and the theme-specific summary associated with that document segment; re-training the trained machine-learning model based on the document embeddings to produce a re-trained machine-learning model; and executing an inference stage of the re-trained machine-learning model over the query to cause outputting a recommended asset portfolio.

2. The computer-implemented method of clause 1 further comprising generating a query embedding for the query; determining a plurality of document embedding score values for the plurality of document embeddings of each document segment among the plurality of document segments based on the query embedding; and re-training the machine-learning model further based on the plurality of document embedding score values for the plurality document embeddings of each document segment.

3. The computer-implemented method of clause 2, wherein the query comprises instructions expressing one or more of a theme, a query expansion, or a position side associated with the theme, the method further comprising generating the query embedding based on one or more of the theme, the query expansion, or the position side associated with the theme.

4. The computer-implemented method of clause 2, wherein the recommended asset portfolio comprises asset identifier values corresponding to one or more assets, the method further comprising determining asset score values for the one or more assets based on the document embedding score values; ranking the one or more assets based on their respective asset score values; and outputting an ordered list of the one or more assets based on the ranking.

5. The computer-implemented method of clause 4 further comprising re-training the machine-learning model further based on the asset score values for the one or more assets.

6. The computer-implemented method of clause 1, wherein the recommended asset portfolio comprises asset identifier values corresponding to one or more assets, each of the assets being associated with one or more of a weight, an asset type, one of the asset identifier values, an asset description, a theme, a theme relevancy score, a factor, or a factor value.

7. The computer-implemented method of clause 1 further comprising repeating the re-training of the machine-learning model continuously based on a specified frequency or timing.

8. The computer-implemented method of clause 1, wherein each document of the set of documents is associated with a timestamp that is after a threshold time, the method further comprising identifying the set of digitally stored documents based on their respective timestamps being after the threshold time.

9. The computer-implemented method of clause 1 further comprising determining a position side associated with the theme for each document segment; and generating the document embeddings for the document segments of each document, the document embedding for each document segment further embedding the position side associated with the theme associated with that document segment.

### 2. Structural & Functional Overview

### 2.1 Overview of Updating a Machine-Learning Model

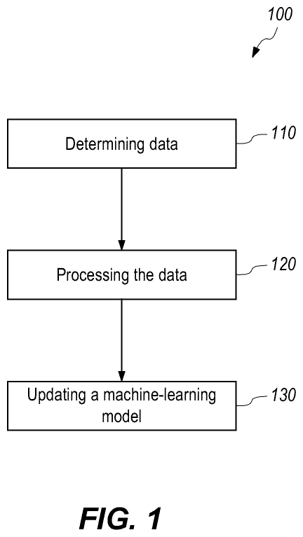

FIG. 1 illustrates an example of a computer-implemented method of updating a machine-learning model. Each step of FIG. 1 can be implemented under stored program control using software prepared using any appropriate programming language and executed using a computer system. In an embodiment, the computer system comprises components implemented partially by hardware at one or more computing devices, such as hardware processors executing stored program instructions stored in one or more memories for performing the functions described herein. In other words, all functions described herein are intended to indicate operations performed using programming in a special or general-purpose computer in various embodiments. The drawing figures illustrate only one of many possible arrangements of components configured to execute the programming described herein. Other arrangements may include fewer or different components, and the division of work between the components may vary depending on the arrangement.

FIG. 1, and the other drawing figures and all of the description and claims in this disclosure, are intended to present, disclose, and claim a technical system and technical methods in which specially programmed computers, using a special-purpose distributed computer system design, execute functions that have not been available before to provide a practical application of computing technology to the problem of updating machine-learning models. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

FIG. 1 and each other flow diagram herein are intended as an illustration of the functional level at which skilled persons, in the art to which this disclosure pertains, communicate with one another to describe and implement a computer-implemented method, as described further herein and/or algorithms using programming. The flow diagrams are not intended to illustrate every instruction, method object, or sub-step that would be needed to program every aspect of a working program but are provided at the same functional level of illustration that is normally used at the high level of skill in this art to communicate the basis of developing working programs.

In the example method 100, at step 110, a computer system may determine data to be used for updating a machine-learning model. At step 120, the computer system may process the data. At step 130, the computer system may update the machine-learning model using the processed data. Although this disclosure describes and illustrates an example method for updating a machine-learning model, including the particular steps of the method of FIG. 1, this disclosure contemplates any suitable method for updating a machine-learning model, including any suitable steps, which may include all, some, or none of the steps of the method of FIG. 1, where appropriate.

In an embodiment, the computer system may optionally receive a query, update a machine-learning model, and optionally return an output for the query using the updated machine-learning model. The machine-learning model can be a thematic portfolio model or any other suitable model. For example, updating the machine-learning model can include finetuning, augmenting, modifying, retraining, and/or otherwise updating the machine-learning model. Updating the machine-learning model can include determining a set of documents (e.g., recent documents), processing the documents, and updating the machine-learning model based on the processed documents. For example, processing the documents can include segmenting each (parent) document into document segments and processing each document segment using a processing model. In a specific example, the processing model can output, for each theme in a set of themes: the theme, a theme-specific summary (e.g., a summary of the document segment in the context of the theme; a description of how a theme is represented in the document segment; etc.), and/or a position side (e.g., long, or short) for the theme. A position side refers to whether an investor has a “long position” (expecting the stock price to rise and buying shares) or a “short position” (expecting the price to fall and essentially borrowing shares to sell, then repurchasing them later at a lower price).

In the first embodiment, updating the machine-learning model can include finetuning the model (e.g., a thematic portfolio model) based on the processed document segments. In a second embodiment, updating the machine-learning model can include embedding the processed document segments and augmenting the model output using the processed document embeddings. For example, a processed document embedding can be generated for each theme, wherein each processed document embedding can be generated based on the theme, the associated theme-specific summary, and/or the position side for the theme. For example, updating the machine-learning model can include embedding a processed and/or unprocessed query (e.g., the query, a query expansion, and/or a position side), scoring processed document embeddings based on the query embedding (e.g., comparing the query embedding to processed document embeddings), scoring assets based on the embedding scores, and updating the model based on the asset scores.

### 2.2 Technical Advantages

The embodiments disclosed herein can confer one or more technical advantages over conventional technologies.

Conventional large language models (LLMs) are trained using data that is not current (e.g., the training data does not include documents from the previous day, week, month, year, etc.). The embodiments disclosed herein can update LLMs and/or other models to account for recent data. For example, the recent data can include documents longer than the context limits for an LLM. In an embodiment, the computer system can segment documents and transform the individual document segments using a first LLM (e.g., a processing model) to update a second LLM (e.g., a thematic portfolio model). The segmentation can improve the computational efficiency of updating the machine-learning model and/or enable large documents to be used for model updating.

In another embodiment, the computer system can transform the recent data (e.g., document segments in the recent data) using a theme-specific transformation to make the data meaningful for that specific theme. Transforming the recent data using a theme-specific transformation can improve the accuracy of the updated machine-learning model and/or improve the computational efficiency in updating the machine-learning model (e.g., relative to retraining the machine-learning model). For example, transforming a document segment can include generating a theme-specific summary for the document segment (e.g., using an LLM).

In another embodiment, the computer system can embed processed data (e.g., theme-specific summaries) and use the embeddings to update the machine-learning model. The computer system can use vector search methods to identify relevant embeddings (and associated assets) for a user query (e.g., comparing processed data embeddings to an embedding for the query), wherein the relevant embeddings can be used to augment an output from a machine learning model. Embedding processed data and using the embeddings to update the machine-learning model can provide a more computationally efficient method of updating the machine-learning model.

Variant embodiments disclosed herein can be specific to updating thematic portfolio models and/or can be used to update other models.

Although this disclosure describes particular technical advantages in a particular manner, other suitable technical advantages will be readily apparent to one skilled in the art from the following figures, descriptions, and claims. Moreover, while specific advantages have been enumerated above, various embodiments may include all, some, or none of the enumerated advantages.

### 2.3 Determining Data

As shown in FIG. 1, method 100 can include determining data, processing the data, and updating a machine-learning model. However, method 100 can additionally include any other suitable steps.

In variant embodiments, method 100 can update a machine-learning model using recent data and/or other supplemental data. For example, updating a model can include finetuning, augmenting, modifying, retraining, and/or otherwise updating the model. Updating a machine-learning model can include updating the machine-learning model itself, updating training data, updating model outputs, and/or otherwise updating the machine-learning model. In a specific example, method 100 can function to update a thematic portfolio model. However, method 100 can have any other suitable functionality.

One or more instances of method 100 can be performed for one or more themes, one or more sets of training data and/or portions thereof (e.g., documents, document segments, etc.), one or more queries, one or more users, one or more machine-learning models (e.g., thematic portfolio models), one or more thematic asset portfolios, one or more assets, one or more factors, one or more times (e.g., timestamps, time windows, time intervals, etc.), one or more data sources, and/or otherwise repeated. Method 100 can optionally be performed periodically (e.g., at a predetermined frequency such as daily, weekly, monthly, yearly, randomly, etc.; every time a query is received from a user device; in response to receiving updated data; or at any other suitable frequency and/or timing).

All or portions of method 100 can be performed by a computer system, using a database (e.g., a system database, a third-party database, etc.), using a user interface, by a user, and/or by any other suitable system. The user interface can receive one or more inputs (e.g., from a user device), display outputs (e.g., model outputs), and display any other parameters and/or functions. The computer system can include one or more CPUs, GPUs, TPUs, custom FPGA/ASICS, microprocessors, servers, cloud computing, and/or other suitable components. The computer system is preferably remote (e.g., a platform). Still, it can additionally and/or include a local computer system, a third-party computer system, a distributed computer system, and/or any other suitable computer system. The computer system can be centralized or decentralized. The computer system preferably interfaces with users directly (e.g., via the user interface). Still, it can additionally and/or interface with users indirectly, not interface with users and/or otherwise. The computer system can interface with external systems (e.g., data sources) using a set of communication mechanisms (e.g., APIs, webhooks, pub/sub architectures, etc.) and/or otherwise interact (e.g., read and/or write data) with external systems. The database can store embeddings, thematic asset portfolios (e.g., sets of assets, optionally with associated weights), factor values, aggregated data (e.g., aggregated data derived from factor values, etc.), and/or other suitable information.

The method 100 can be used with one or more machine-learning models, including processing models, query processing models, representation models, thematic portfolio models, scoring models, and/or other models.

All or a subset of the machine-learning models described herein can include and/or leverage one or more: neural networks (e.g., CNN, DNN, encoders, decoders, transformer models, language models, etc.), foundation models (e.g., large language models), equations (e.g., weighted equations), regression (e.g., leverage regression), classification (e.g., leverage classification), rules, heuristics, statistical methods (e.g., probability), decision trees, clustering methods, ensemble methods, instance-based methods (e.g., nearest neighbor), vector search models, comparison methods (e.g., matching, distance metrics, thresholds, etc.), and/or any other suitable model or methodology.

The machine-learning models can include (e.g., be constructed using) a set of input layers, output layers, and hidden layers (e.g., connected in series, such as in a feed-forward network, connected with a feedback loop between the output and the input, such as in a recurrent neural network; etc.; wherein the layer weights can be learned through training); a set of connected convolution layers (e.g., in a CNN); a set of self-attention layers; and/or have any other suitable architecture.

The machine-learning models can be retrieved from a repository, trained, received from a third-party system, and/or otherwise determined. The machine-learning models can be trained, learned, fit, predetermined, and/or can be otherwise determined. The machine-learning models can be trained using self-supervised learning, semi-supervised learning, supervised learning, unsupervised learning, transfer learning, reinforcement learning, and/or any other suitable training method. The machine-learning models can be trained in-house, by a third party, and/or by any other suitable entity.

The machine-learning models can be trained hourly, daily (e.g., during trading days only), weekly, bi-weekly, monthly, and/or at any other suitable frequency. The system can include a single machine-learning model shared across all users, a different machine-learning model for each user, a different model for each set of users, and/or be otherwise configured. The training target for the machine-learning models can be binary, non-binary, numerical, categorical, and/or any other suitable characteristics. The training data can be determined from synthetic data and/or real data. The training data can be determined from in-house data and/or third-party data.

The method 100 can be used with one or more thematic asset portfolios. The thematic asset portfolio can be a hypothetical asset portfolio (e.g., assets not currently owned, assets cannot be traded, etc.) but can additionally and/or be a real asset portfolio (e.g., assets are owned, assets can be traded, etc.), be a blended portfolio (e.g., incorporating owned and unowned assets), and/or include any other suitable set of assets. The thematic asset portfolio can be associated with a theme (e.g., from a microeconomic and/or macroeconomic perspective) but can additionally and/or not be associated with a theme. Themes can be related to industries (e.g., technology, healthcare, financials, consumer goods, energy, etc.); sectors (e.g., software, hardware, cloud computing, artificial intelligence, etc.); geographic regions (e.g., countries, states, cities, domestic, international, etc.); market indices (e.g., S&P 500, NASDAQ, Dow Jones Industrial Average, etc.); environmental, social, and governance (e.g., sustainability, ethical practices, corporate governance, etc.); currencies (e.g., exchange rates); inflation rates; interest rates; events (e.g., a current event, a historical event, etc.); politics (e.g., political instability); regulations; supply chains; cybersecurity; technological disruptions (e.g., technological advancements such as artificial intelligence); demographics; geopolitics (e.g., geopolitical tensions and conflicts); an unstructured theme (e.g., that does not fall within a predetermined category); and/or any other suitable theme.

The method 100 can be used with one or more assets. For example, the thematic asset portfolio can include one or more assets. Each asset can be a current asset (e.g., liquid assets, assets that can be easily converted into cash and cash equivalents typically within a year, etc.) but can additionally and/or be a non-current asset (e.g., fixed assets, assets that cannot be easily converted into cash and cash equivalents, etc.), and/or any other suitable asset. The asset can be associated with an asset type or not be associated with an asset type. Asset types can include cash, equities, fixed income, and/or any other suitable asset type. Assets can include cash and/or cash equivalents, money market funds, U.S. treasury bills, certificates of deposit (CDs), stocks, dividend payments, bonds, and/or any other suitable asset. The asset can be associated with an asset identifier (e.g., ticker symbol, company name, internal identifier, etc.), an asset description, a theme, a set of factors, a set of features, a theme relevancy score, and/or other information. The asset information can be output by the thematic portfolio model, obtained from a third-party system (e.g., Barra™, NYSE, etc.), determined by the system, and/or otherwise determined. The asset description can be associated with a theme (e.g., the same theme associated with the thematic asset portfolio, a different theme, etc.) but can additionally and/or be associated with an asset type, an asset identifier, and/or any other suitable asset information. The asset description can be generated by the thematic portfolio model but can alternatively be selected (e.g., based on the theme, such as based on a distance metric between the theme and each candidate description for the asset, etc.) and/or otherwise determined. The asset can be selected from a set of tradeable assets (e.g., determined by the system, determined based on compliance and/or regulations, etc.) but can additionally and/or be selected from a different set of assets and/or otherwise selected. The set of tradeable assets can be fixed and/or dynamic.

The method 100 can be used with one or more factors and/or factor values. Factors can be associated with an asset, a set of assets, relationships between assets, market conditions, and/or any other suitable parameter. Each factor can be associated with a factor description (e.g., text description, semantic description, etc.) or not be associated with a factor description. The factors can be features extracted from historical data for a set of assets over time (e.g., time series of data of the asset set) but can additionally be extracted from other factors, extracted from market-related information (e.g., news, etc.), and/or otherwise determined. The factors can be statistical measures but can alternatively be otherwise determined. The factors can be retrieved from a third-party system (e.g., Barra™, etc.), calculated by the system, and/or otherwise determined.

Examples of factors can include: market risk (e.g., sensitivity of investment to overall market movements); size (e.g., risk associated with market capitalization of a company); value (e.g., risk associated with valuation of a company); momentum (e.g., risk associated with a recent price trend of an asset); volatility (e.g., risk associated with volatility or unpredictability of an asset's returns); liquidity (e.g., risk associated with the case of buying or selling an asset without significantly impacting its price); price-to-earnings ratio; growth; quality (e.g., risk associated with a financial health and quality of a company); yield (e.g., risk associated with a company's dividend yield); term spread (e.g., risk associated with the difference between long term and short term interest rates); credit spread (e.g., risk associated with difference between yields on corporate bonds and government bonds); currency (e.g., risk associated with changes in exchange rates); commodity (e.g., risk associated with changes in commodity prices); country risk (e.g., risk associated with investing in a specific country); inflation (e.g., risk associated with changes in inflation rates); leverage (e.g., risk associated with a company's level of debt); default (risk associated with the likelihood of a company defaulting on its debt obligations); interest rate (e.g., risk associated with changes in interest rates); real estate (e.g., risk associated with real estate investments); industry (e.g., risk associated with specific industries); environmental, social, and governance (e.g., risk associated with a company's environmental, social, and governance practices); illiquidity (e.g., risk associated with trading in illiquid markets); event risk (e.g., risk associated with specific events that can impact an investment's value); systemic risk (e.g., risk associated with broader systemic factors that affect entire markets or the financial system as a whole); model risk (e.g., risk associated with accuracy and reliability of quantitative models used for assessments); political risk (e.g., risk associated with political instability); regulatory risk (e.g., risk associated with changes in regulations that affect the operations and/or profitability of companies and industries); market sentiment (e.g., risk associated with shifts in investor sentiment and market psychology); supply chain risk (e.g., risk associated with disruptions in a company's supply chain); cybersecurity risk (e.g., risk associated with cyber threats and data breaches); technological disruption (e.g., risk associated with technological advancements that can disrupt industries and traditional business models); demographic risk (e.g., risk associated with changes in demographics such as aging populations); geopolitical risk (e.g., risk associated with geopolitical tensions and conflicts); and/or any other suitable factor. The factors can be semantic (e.g., have human meaning) or non-semantic. The factors can be determined by the system, obtained from a third-party system (e.g., Barra™), and/or otherwise determined.

In an embodiment, when determining data at step 110 illustrated in FIG. 1, the computer system may determine recent data and/or any other supplemental data that can be used to update (e.g., augment) a machine-learning model of interest. The step of determining data can be performed after the machine-learning model of interest has been trained (e.g., trained using older data), in response to receiving a query from a user device, in response to receiving updated data, periodically (e.g., at a predetermined frequency such as daily, weekly, monthly, yearly, randomly, any other frequency), and/or at any other time. In a specific example, the data can correspond to data (e.g., SEC filings) for all or a portion of the current trading assets.

The data (e.g., training data, augmentation data, etc.) can optionally include data with an associated timestamp that is after a threshold time (e.g., the data can include only data with a timestamp after the threshold time). For example, the threshold time can be between 1 hour-5 years or any range or value therebetween (e.g., 24 hours, 48 hours, 1 week, 1 month, 6 months, 1 year, etc.), but can alternatively be less than 1 hour or greater than 5 years. The threshold time can optionally be a time corresponding to the latest date for training data used to train the machine-learning model of interest and/or a time corresponding to a previous instance of the machine-learning model (e.g., the last time the machine-learning model was updated).

The data can include unstructured data and/or structured data. The data can include real data but can additionally and/or include synthetic data. The training data can be retrieved from a database, received from a third-party system (e.g., from Barra™, from Security & Exchange Commission's (SEC) EDGAR, OneTick™, news sources, etc.), synthetically generated, and/or otherwise determined.

The data can include documents but can additionally include any other data. Each document and/or other data element can optionally be associated with values for data parameters (e.g., document information). Examples of data parameters include assets (e.g., assets associated with the document), asset information, factor values, data source, time, document summary, document header, document identifier, and/or any other information associated with the document. The data preferably includes document text but can additionally include metadata (e.g., data parameter values) and/or any other data type.

Although this disclosure describes determining particular data in a particular manner, this disclosure contemplates determining any suitable data.

### 2.4 Processing Data

When processing the data at step 120, illustrated in FIG. 1, the computer system may segment the data, transform the data for a domain of interest (e.g., for a specific theme, for a specific query, etc.), and/or otherwise process the data for downstream use. For example, processing the data can include data cleaning, text extraction, data transformation, data reduction, data segmentation, data summarization, data analysis, a combination thereof, and/or any other processing methods.

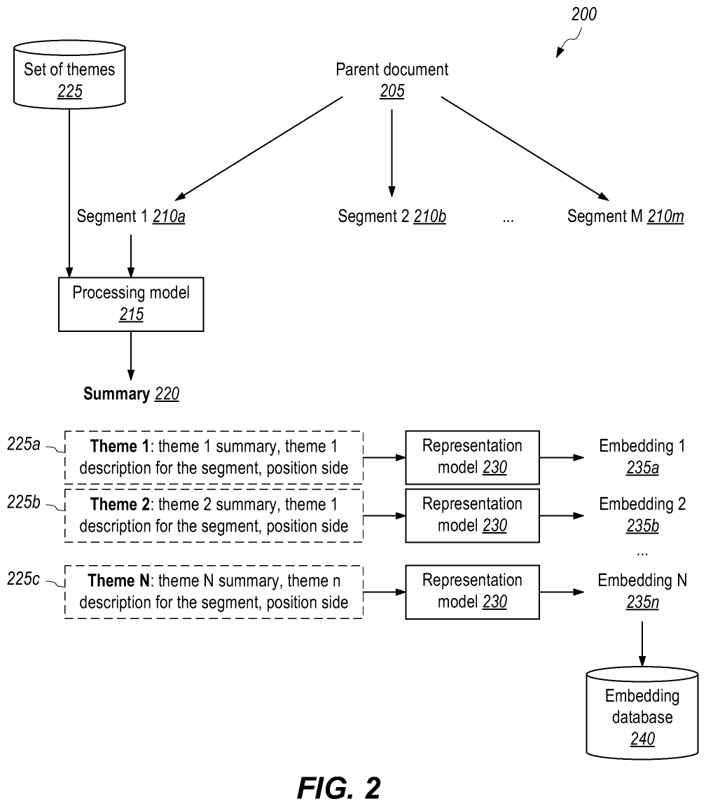

FIG. 2 illustrates an example of computer-implemented method 200 of processing the data. In an embodiment, processing the data may include segmenting the data into data segments. Data segments can be overlapping and/or non-overlapping. For example, all or portions of a parent document 205 (e.g., sections of interest in the parent document 205) can be segmented such that each document segment 210 (e.g., document section) is less than a threshold segment size. The segment size can optionally be determined based on a context limit (e.g., token limit) for a processing model 215 and/or any other model. In some embodiments, the threshold segment size can be less than a context limit. Each document segment 210 can optionally include and/or be associated with data parameter values (e.g., document information) associated with the parent document 205 (e.g., to retain context for the document segment 210, to track document segment 210 relationship to the parent document 205, etc.) and/or information associated with neighboring document segments 210 (e.g., to track document segment 210 relationship to neighboring document segments 210). Each data segment 210 (e.g., document segment 210) can optionally be further processed (e.g., cleaned, summarized, transformed, etc.). For example, all or a portion of data processing can be performed for each data segment 210. In some embodiments, data segments 210 can be processed serially, in parallel, and/or otherwise. As used herein, “data” can optionally refer to a data segment 210 (e.g., document segment).

In an embodiment, processing the data may include generating a summary 220 for the data (e.g., the parent document 205 and/or a data segment 210) using a processing model 215. Generating the summary for the data may be optional. In a specific example, generating a summary 220 includes extracting one or more themes 225 from the data. The processing model 215 can be a large language model (LLM) or any other model. In some embodiments, inputs to the processing model 215 can include the data (e.g., segments 210), data parameter values, a set of themes 225, and/or any other suitable inputs. In a specific example, inputs to the processing model can include a document segment (e.g., text in the document segment), document information (e.g., for the parent document), and/or a set of themes. In some embodiments, outputs from the processing model 215 can include a general summary 220 for the data (e.g., for a document segment 210 and/or for a parent document 205), one or more themes 225, a theme-specific summary, a position side (e.g., long or short) for a theme 225, and/or any other suitable outputs. In a specific example, outputs from the processing model can include, for each of the themes 225: the theme 225, a theme-specific summary (e.g., a summary of the data and/or data segment 210 in the context of the theme 225; a description of how a theme 225 is represented in the data and/or data segment 210; etc.), and a position side for the theme 225. The set of themes 225 can be retrieved from a database, determined based on a query, determined using a model (e.g., the model takes the data as input and outputs relevant themes), and/or otherwise determined. In a specific example, for each data segment 210, the processing model 215 can output a structured JSON document.

In an embodiment, processing the data includes embedding the data (e.g., a data segment) and/or one or more associated summaries 220. For example, all or a portion of the output of the processing model 215 can be embedded using a representation model 230. The representation model 230 can be an encoder, an LLM (e.g., Llama2), and/or any other model. The representation model 230 can be general across themes but alternatively be theme-specific. Inputs to the representation model 230 can include a theme 225, a theme-specific summary, a position side, data and/or associated information (e.g., data parameter values), and/or any other suitable inputs. In some embodiments, the input to the representation model 230 can be a string (e.g., text). For example, for a document segment 210, the representation model 230 can generate one embedding 235 for each theme 225. Each embedding 235 can be generated based on theme 225 (e.g., theme title/description), the associated theme-specific summary, and/or the position side for theme 225. Outputs from the representation model 230 can include an embedding 235 (e.g., vector) and/or other outputs. Each embedding 235 (e.g., processed data embedding 235) can optionally be stored in an embedding database 240 and/or any other database. The computer system can optionally store the embedding 235 in association with the theme 225 for embedding 235, document information for the parent document 205 (e.g., tracking relevant assets for embedding 235), and/or any other information.

In an embodiment, a combination of all or a portion of segmenting the data into data segments, generating a summary 220 for the data (e.g., a data segment) using a processing model 215, embedding the data (e.g., a data segment) and/or one or more associated summaries 220 can be used. However, the data can be otherwise processed.

### 2.5 Model Updating

When updating a machine-learning model at step 130 illustrated in FIG. 1, the computer system may update a (trained) machine-learning model using the processed data. In some embodiments, updating the machine-learning model can include finetuning, augmenting, modifying, retraining, and/or otherwise updating the machine-learning model. Updating the machine-learning model can include updating the machine-learning model itself, updating an output from the machine-learning model, updating training data for training the machine-learning model, and/or otherwise updating the machine-learning model. The machine-learning model can be trained (e.g., pretrained) using training data that does not include data determined in step 110 described in FIG. 1. Alternatively, the machine-learning model can be trained using data determined in step 110 described in FIG. 1 and/or can be not trained. In an embodiment, the machine-learning model can be trained using training data older than a threshold time (e.g., with a timestamp older than a threshold time). For example, the threshold time can be between 1 hour and 5 years or any range or value therebetween (e.g., 24 hours, 48 hours, 1 week, 1month, 6 months, 1 year, etc.), but can alternatively be less than 1 hour or greater than 5 years.

The machine-learning model can be a foundation model (e.g., an LLM), but can additionally or include any other model. The machine-learning model can be a thematic portfolio model (e.g., for thematic asset portfolio determination), but can be any other model. In an embodiment, inputs to the thematic portfolio model can include a processed and/or unprocessed query, position side (e.g., short or long), a set of system prompts (e.g., defines how the thematic portfolio model should be prompted), factor values, factor descriptions, feedback, and/or any other suitable inputs.

A query (e.g., theme) can be received from a user device (e.g., on an interface, through an API, etc.), a computer, a platform, and/or any other suitable source. The query can specify a request for a recommendation of an asset portfolio. The query can include unstructured data and/or structured data. The query can include a string (e.g., text) but can additionally and/or include an integer, a character, a Boolean, a date, a time, and/or any other suitable data type. In some embodiments, outputs from the thematic portfolio model can include a set of assets (e.g., asset identifiers for a thematic asset portfolio), theme summaries (e.g., a summary of a theme), theme descriptions (e.g., describes a theme from a microeconomic and/or macroeconomic perspective), asset descriptions (e.g., describes why an asset and/or a company was selected for a theme), position sides (e.g., long position, short position, etc.), scores (e.g., a score for each asset), uncertainty parameters (e.g., confidence intervals, confidence bands, etc.), and/or any other suitable outputs. In a specific example, the thematic portfolio model can output assets ranked based on the associated score for each asset.

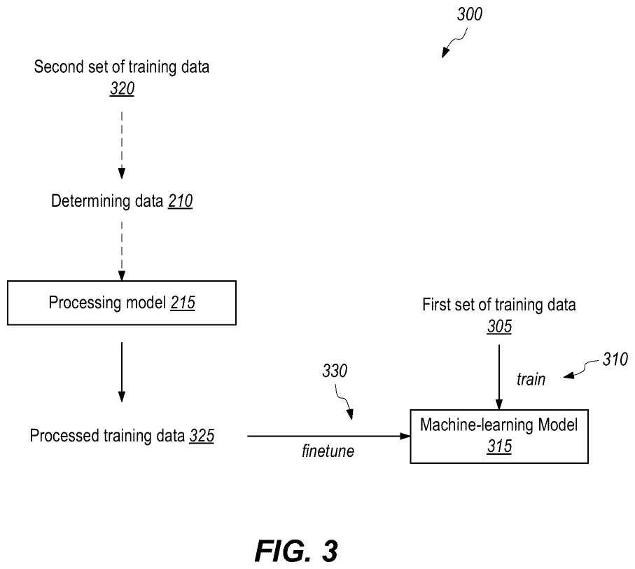

FIG. 3 illustrates an example method 300 for finetuning a machine-learning model. In an embodiment, updating the machine-learning model can include finetuning the machine-learning model based on the processed data (e.g., data processed in step 120 described in FIG. 1). As illustrated in FIG. 3, the computer system may use a first set of training data 305 (e.g., old data) to train the machine-learning model 315 (e.g., a thematic portfolio model) at operation 310. The computer system may access a second set of training data 320 (e.g., recent data) and generate data segments 210 for the second set of training data 320. The computer system may use the processing model 215 to generate processed training data 325. For example, for each data of the second set of training data 320 and/or data segment 210, the processed training data 325 may include one or more themes 225, theme-specific summaries, and/or position sides, which can be used to finetune the machine-learning model 315 at operation 330. Processed training data 325 for a data segment 210 can optionally be augmented with data parameter values (e.g., document information for the associated parent document 205). In variant embodiments, augmenting the processed training data 325 can provide additional context for the processed training data 325, improving the model finetuning.

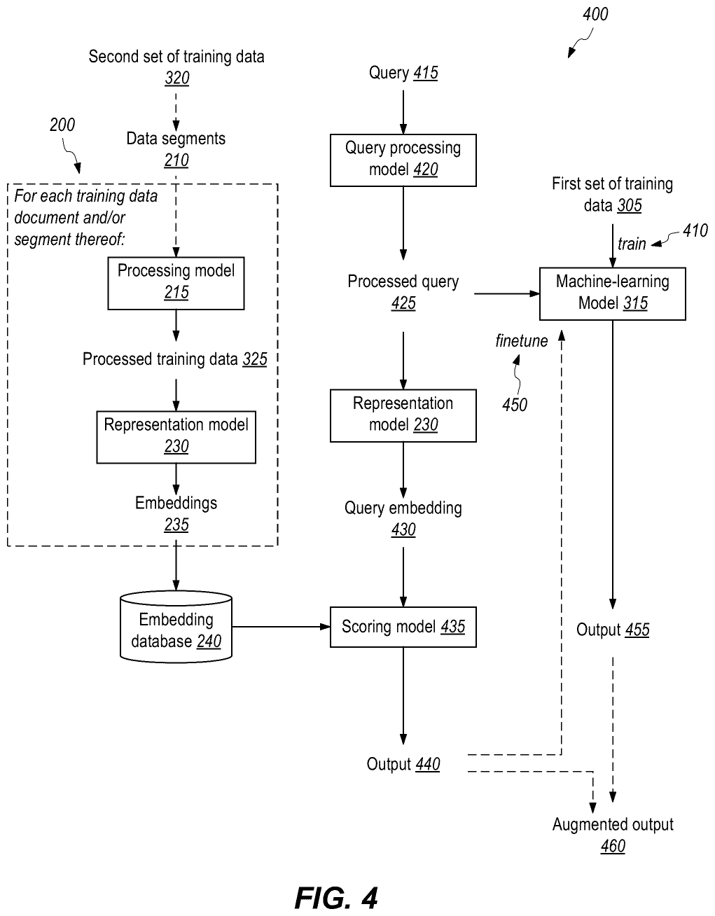

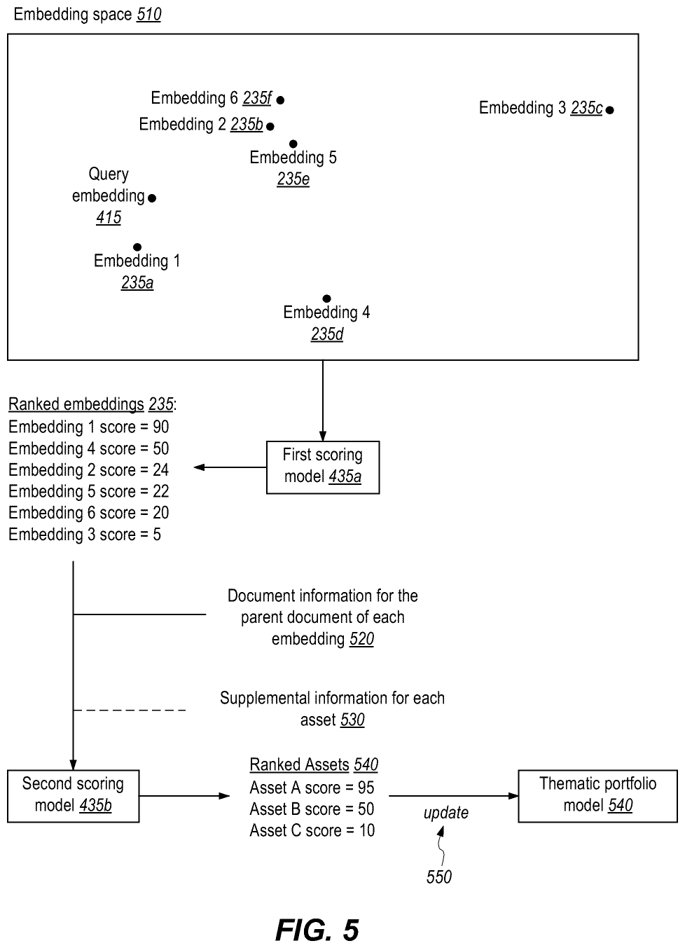

In an embodiment, updating the machine-learning model 315 can include updating the machine-learning model 315 using processed data embeddings 235. FIG. 4 illustrates an example method 400 for updating the machine-learning model 315 using processed data embeddings 235. FIG. 5 illustrates another example of method 500 for updating the machine-learning model 315 using processed data embeddings 235.

In the embodiment illustrated in FIG. 4, the computer system may use a first set of training data 305 (e.g., old data) to train the machine-learning model 315 (e.g., a thematic portfolio model) at operation 410. The computer system may access a second set of training data 320 (e.g., recent data) and generate data segments 210 for the second set of training data 320. The computer system may then use method 200 to generate embeddings 235 for the data segments 210. For each training data 320 and/or segment 210 thereof, the computer system may use the processing model 215 to generate processed training data 325, use the representation model 230 to generate embeddings 235 and store the embeddings 235 in the embedding database 240.

As illustrated in FIG. 4, the computer system may embed the query 415, evaluate (e.g., score) one or more processed data embeddings 235 (e.g., in the embedding database 240) based on the query embedding 430, and update the machine-learning model 315 based on the embedding scores.

Embedding the query 415 can include embedding a processed query 425 and/or unprocessed query 415 using a representation model 230. For example, query 415 can include a theme and/or include information associated with a theme. The query 415 can optionally be processed using a query processing model 420 to generate a processed query 425. For example, the query processing model 420 can be an LLM, a thematic portfolio model, the same or a different processing model 215 as used in method 200, and/or any other model. The processed query 425 can include a theme, a theme summary, a query expansion, a position side (e.g., long or short) associated with the query 415 and/or theme, and/or any other information. In a specific example, the query expansion can be or include a theme description (e.g., a description of the query 415 or theme from a microeconomic and/or macroeconomic perspective, a description of possible microeconomic and/or macroeconomic effects associated with the query 415, etc.).

In some embodiments, the representation model 230 (e.g., the same representation model 230 used in method 200 or a different representation model 230) can embed the theme (e.g., the query 415 and/or a theme generated based on the query 415), the query expansion, and/or the position side.

Evaluating one or more processed data embeddings 235 based on the query embedding 430 can include scoring all or a subset of the processed data embeddings 235 using a scoring model 435 (e.g., embedding scoring model). Inputs to the scoring model 435 can include a query embedding 430, a processed data embedding 235 of interest (e.g., a theme-specific embedding 235 for a document segment 210), other processed data embeddings 235, and/or any other suitable inputs. Output 440 from the scoring model 435 can include a score for the processed data embedding 235. The scoring model 435 can use a k-nearest neighbor algorithm, clustering methods, a vector search model, an LLM, comparison methods (e.g., a distance metric such as a distance between the query embedding 430 and the processed data embedding 235 in an embedding space), and/or any other models. The output 440 can be used to finetune the machine-learning model 315 at operation 450.

The method 400 can optionally include returning (e.g., to a user device) an output 455 using the updated machine-learning model 315. In an embodiment, the computer system may execute the inference stage of the updated machine-learning model 315 over query 415. For example, the output 455 can be a query result. The Output 455 can include a thematic asset portfolio, including asset identifier values corresponding to one or more assets, an analysis of a thematic asset portfolio, and/or any other suitable result. However, the output 455 can be otherwise returned.

In an embodiment, the computer system may augment the output 455 using the output 440. As a result, the computer system may generate an augmented output 460 (e.g., a final thematic portfolio). For example, the computer system may use the scores in output 440 to rank assets in output 455 and select a subset of assets based on their ranking to determine a final thematic portfolio.

In the embodiment illustrated in FIG. 5, the scoring model 435 can optionally weigh the score for a processed data embedding 235 of interest based on other (nearby) processed data embeddings 235. For example, a first scoring model 435a can weigh the scores based on how crowded the local embedding space 510 is (e.g., local to the processed data embedding 235 of interest). In an embodiment, the score can be downweighted if the local embedding space 510 is crowded and/or upweighted if the local embedding space 510 is sparse but can alternatively be upweighted if the local embedding space 510 is crowded and/or downweighted if the local embedding space 510 is sparse. The processed data embeddings 235 can optionally be ranked based on the associated scores. A subset of the processed data embeddings 235 (e.g., relevant processed data embeddings) can optionally be selected. For example, the highest scoring processed data embeddings 235 can be selected as processed data embeddings 235 relevant to the query 415.

Updating the machine-learning model 315 based on the embedding scores can include scoring assets based on the embedding scores and updating the machine-learning model 315 based on the asset scores. However, any other information associated with the processed data embeddings 235 can be scored and/or used to update the machine-learning model 315. For example, for all or a subset of the processed data embeddings 235 (e.g., for the relevant processed data embeddings 235), each processed data embedding 235 can be mapped to the associated document segment, parent document, and/or data parameter values (e.g., assets). Assets can optionally be scored using a second scoring model 435b (e.g., asset scoring model). Inputs to the asset scoring model 435b can include document information 520 (e.g., associated assets) for the parent document 205 of each embedding 235, supplemental information 530 for each asset (e.g., market cap, liquidity, etc.), and/or any other suitable inputs. For example, document information 520 may include a count associated with the asset (e.g., the number of times the asset is associated with a relevant processed data embedding 235).

Outputs from the asset scoring model 435b can include a score (e.g., weight) for the asset. The assets (e.g., a deduplicated list of assets) can optionally be ranked based on the associated scores. A subset of the assets (e.g., relevant assets) can optionally be selected. In a specific example, the highest-scoring assets can be selected. The ranked assets 535 with the asset scores, subset of assets, and/or any other updated asset information can optionally be used to update a thematic portfolio model 540 at operation 550. In some embodiments, the output from the thematic portfolio model 540 can be updated based on the asset scores, ranked asset list, and/or subset of assets. For example, an asset score output by the thematic portfolio model 540 can be adjusted based on an (updated) asset score determined using the asset scoring model 435b (e.g., to match the updated asset score). As another example, an asset list output by the thematic portfolio model 540 can be adjusted based on an (updated) ranked asset list (e.g., adjusting the asset ranking, adding new assets, etc.). However, a thematic portfolio model 540 can be otherwise updated.

Different subsystems and/or modules discussed above can be defined, operated, and/or controlled by the same or different entities. In some embodiments, different subsystems can communicate via APIs (e.g., using API requests and responses, API keys, etc.), requests, and/or other communication channels.

### 3. Implementation Example—Hardware Overview

According to one embodiment, the techniques described herein are implemented by at least one computing device. The techniques may be implemented in whole or in part using a combination of at least one server computer and/or other computing devices coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. To accomplish the described techniques, such computing devices may also combine custom hard-wired logic, ASICs, or FPGAs with custom programming. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

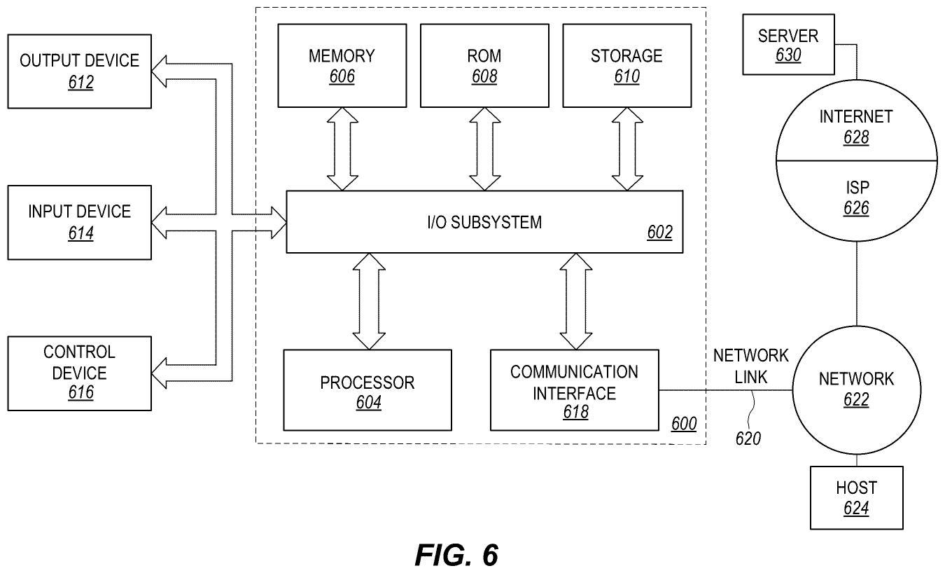

FIG. 6 is a block diagram that illustrates an example computer system with which an embodiment may be implemented. In the example of FIG. 6, a computer system 600 and instructions for implementing the disclosed technologies in hardware, software, or a combination of hardware and software are represented schematically, for example, as boxes and circles, at the same level of detail that is commonly used by persons of ordinary skill in the art to which this disclosure pertains for communicating about computer architecture and computer systems implementations.

Computer system 600 includes an input/output (I/O) subsystem 602, which may include a bus and/or other communication mechanisms for communicating information and/or instructions between the components of the computer system 600 over electronic signal paths. The I/O subsystem 602 may include an I/O controller, a memory controller, and at least one I/O port. The electronic signal paths are represented schematically in the drawings, for example, as lines, unidirectional arrows, or bidirectional arrows.

At least one hardware processor 604 is coupled to I/O subsystem 602 for processing information and instructions. Hardware processor 604 may include, for example, a general-purpose microprocessor or microcontroller and/or a special-purpose microprocessor such as an embedded system, a graphics processing unit (GPU), a digital signal processor, or an ARM processor. Processor 604 may comprise an integrated arithmetic logic unit (ALU) or may be coupled to a separate ALU.

Computer system 600 includes one or more units of memory 606, such as a main memory, which is coupled to I/O subsystem 602 for electronically digitally storing data and instructions to be executed by processor 604. Memory 606 may include volatile memory, such as various forms of random-access memory (RAM) or another dynamic storage device. Memory 606 may also be used to store temporary variables or other intermediate information during the execution of instructions to be executed by processor 604. Such instructions, when stored in non-transitory computer-readable storage media accessible to processor 604, can render computer system 600 into a special-purpose machine that is customized to perform the operations specified in the instructions.

Computer system 600 further includes non-volatile memory such as read-only memory (ROM) 608 or other static storage devices coupled to I/O subsystem 602 for storing information and instructions for processor 604. The ROM 608 may include various forms of programmable ROM (PROM), such as erasable PROM (EPROM) or electrically erasable PROM (EEPROM). A unit of persistent storage 610 may include various forms of non-volatile RAM (NVRAM), such as FLASH memory, solid-state storage, magnetic disk, or optical disks such as CD-ROM or DVD-ROM and may be coupled to I/O subsystem 602 for storing information and instructions. Storage 610 is an example of a non-transitory computer-readable medium that may be used to store instructions and data, which, when executed by processor 604, causes performing computer-implemented methods to execute the techniques herein.

The instructions in memory 606, ROM 608, or storage 610 may comprise one or more sets of instructions that are organized as modules, methods, objects, functions, routines, or calls. The instructions may be organized into one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server, or web client. The instructions may be organized as a presentation layer, application layer, and data storage layer, such as a relational database system using a structured query language (SQL) or no SQL, an object store, a graph database, a flat-file system, or other data storage.

Computer system 600 may be coupled via I/O subsystem 602 to at least one output device 612. In one embodiment, output device 612 is a digital computer display. Examples of a display that may be used in various embodiments include a touchscreen display, a light-emitting diode (LED) display, a liquid crystal display (LCD), or an e-paper display. Computer system 600 may include another type(s) of output devices 612, alternatively or in addition to a display device. Examples of other output devices 612 include printers, ticket printers, plotters, projectors, sound cards or video cards, speakers, buzzers or piezoelectric devices or other audible devices, lamps or LED or LCD indicators, haptic devices, actuators, or servos.

At least one input device 614 is coupled to I/O subsystem 602 for communicating signals, data, command selections, or gestures to processor 604. Examples of input devices 614 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 616, which may perform cursor control or other automated control functions such as navigation in a graphical interface on a display screen, alternatively or in addition to input functions. The control device 616 may be a touchpad, a mouse, a trackball, or cursor direction keys for communicating direction information and command selections to processor 604 and for controlling cursor movement on an output device 612, such as a display. The input device may have at least two degrees of freedom in two axes, a first axis (for example, x) and a second axis (for example, y), that allows the device to specify positions in a plane. Another type of input device is a wired, wireless, or optical control device, such as a joystick, wand, console, steering wheel, pedal, gearshift mechanism, or another type of control device. An input device 614 may include a combination of multiple different input devices, such as a video camera and a depth sensor.

In another embodiment, computer system 600 may comprise an Internet of Things (IoT) device in which one or more of the output device 612, input device 614, and control device 616 are omitted. Or, in such an embodiment, the input device 614 may comprise one or more cameras, motion detectors, thermometers, microphones, seismic detectors, other sensors or detectors, measurement devices or encoders, and the output device 612 may comprise a special-purpose display such as a single-line LED or LCD display, one or more indicators, a display panel, a meter, a valve, a solenoid, an actuator or a servo.

When computer system 600 is a mobile computing device, input device 614 may comprise a global positioning system (GPS) receiver coupled to a GPS module that is capable of triangulating to a plurality of GPS satellites, determining and generating geo-location or position data such as latitude-longitude values for a geophysical location of the computer system 600. Output device 612 may include hardware, software, firmware, and interfaces for generating position reporting packets, notifications, pulse or heartbeat signals, or other recurring data transmissions that specify a position of the computer system 600, alone or in combination with other application-specific data, directed toward host computer 624 or server computer 630.

Computer system 600 may implement the techniques described herein using customized hard-wired logic, at least one ASIC or FPGA, firmware, and/or program instructions or logic which, when loaded and used or executed in combination with the computer system, causes or programs the computer system to operate as a special-purpose machine. According to one embodiment, the techniques herein are performed by computer system 600 in response to processor 604 executing at least one sequence of at least one instruction contained in main memory 606. Such instructions may be read into main memory 606 from another storage medium, such as storage 610. Execution of the sequences of instructions contained in main memory 606 causes processor 604 to perform the process steps described herein. In alternative embodiments, hard-wired circuitry may be used in place of or in combination with software instructions.

The term “storage media,” as used herein, refers to any non-transitory media that store data and/or instructions that cause a machine to operate in a specific fashion. Such storage media may comprise non-volatile media and/or volatile media. Non-volatile media includes, for example, optical or magnetic disks, such as storage 610. Volatile media includes dynamic memory, such as memory 606. Common forms of storage media include, for example, a hard disk, solid-state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wires, and fiber optics, including the wires that comprise a bus of I/O subsystem 602. Transmission media can also be acoustic or light waves, such as those generated during radio-wave and infrared data communications.

Various forms of media may carry at least one sequence of at least one instruction to processor 604 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 600 can receive the data on the communication link and convert the data to a format that can be read by computer system 600. For instance, a receiver such as a radio frequency antenna or an infrared detector can receive the data carried in a wireless or optical signal, and appropriate circuitry can provide the data to I/O subsystem 602 and place the data on a bus. I/O subsystem 602 carries the data to memory 606, from which processor 604 retrieves and executes the instructions. The instructions received by memory 606 may optionally be stored on storage 610 before or after execution by processor 604.

Computer system 600 also includes a communication interface 618 coupled to I/O subsystem 602. Communication interface 618 provides a two-way data communication coupling to a network link(s) 620 directly or indirectly connected to at least one communication network, such as network 622 or a public or private cloud on the Internet. For example, communication interface 618 may be an Ethernet networking interface, integrated-services digital network (ISDN) card, cable modem, satellite modem, or a modem to provide a data communication connection to a corresponding type of communications line, for example, an Ethernet cable or a metal cable of any kind or a fiber-optic line or a telephone line. Network 622 broadly represents a local area network (LAN), wide-area network (WAN), campus network, internetwork, or any combination thereof. Communication interface 618 may comprise a LAN card to provide a data communication connection to a compatible LAN or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 618 sends and receives electrical, electromagnetic, or optical signals over signal paths that carry digital data streams representing various types of information.

Network link 620 typically provides electrical, electromagnetic, or optical data communication directly or through at least one network to other data devices, using, for example, satellite, cellular, Wi-Fi, or BLUETOOTH technology. For example, network link 620 may connect through network 622 to a host computer 624.

Furthermore, network link 620 may provide a connection through network 622 or to other computing devices via internetworking devices and/or computers that are operated by an Internet Service Provider (ISP) 626. ISP 626 provides data communication services through a worldwide packet data communication network called Internet 628. A server computer 630 may be coupled to Internet 628. Server computer 630 broadly represents any computer, data center, virtual machine, or virtual computing instance with or without a hypervisor or computer executing a containerized program system such as DOCKER or KUBERNETES. Server computer 630 may represent an electronic digital service that is implemented using more than one computer or instance, and that is accessed and used by transmitting web services requests, uniform resource locator (URL) strings with parameters in HTTP payloads, API calls, app services calls, or other service calls. Computer system 600 and server computer 630 may form elements of a distributed computing system that includes other computers, a processing cluster, a server farm, or other organization of computers that cooperate to perform tasks or execute applications or services. Server computer 630 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server computer 630 may comprise a web application server that hosts a presentation layer, application layer, and data storage layer, such as a relational database system using a structured query language (SQL) or no SQL, an object store, a graph database, a flat-file system or other data storage.

Computer system 600 can send messages and receive data and instructions, including program code, through the network(s), network link 620, and communication interface 618. In the Internet example, a server computer 630 might transmit a requested code for an application program through Internet 628, ISP 626, local network 622, and communication interface 618. The received code may be executed by processor 604 as it is received and/or stored in storage 610 or other non-volatile storage for later execution.

The execution of instructions, as described in this section, may implement a process in the form of an instance of a computer program that is being executed and consisting of program code and its current activity. Depending on the operating system (OS), a process may comprise multiple threads of execution that execute instructions concurrently. In this context, a computer program is a passive collection of instructions, while a process may execute those instructions. Several processes may be associated with the same program; for example, opening up several instances of the same program often means more than one process is being executed. Multitasking may be implemented to allow multiple processes to share processor 604. While each processor 604 or core of the processor executes a single task at a time, computer system 600 may be programmed to implement multitasking to allow each processor to switch between tasks that are being executed without having to wait for each task to finish. In an embodiment, switches may be performed when tasks perform input/output operations when a task indicates that it can be switched or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims issued from this application in the specific form in which such claims issue, including any subsequent correction.

What is claimed is:

1. A computer-implemented method executed using a first computer and comprising:
receiving, from a second computer, a query specifying a request for a recommendation of an asset portfolio;
in response to receiving the query, identifying a set of digitally stored documents for use in re-training a trained machine-learning model capable of outputting a recommendation of a particular asset portfolio;
generating and storing in memory of the first computer a plurality of document segments for each document of the set of documents;
determining at least a theme and a theme-specific summary for each document segment among the plurality of document segments;
generating a plurality of document embeddings for the plurality of document segments of each document of the set of documents, the document embedding for each document segment embedding the theme, and the theme-specific summary associated with that document segment;
re-training the trained machine-learning model based on the document embeddings to produce a re-trained machine-learning model; and
executing an inference stage of the re-trained machine-learning model over the query to cause outputting a recommended asset portfolio.

2. The computer-implemented method of claim 1 further comprising:
generating a query embedding for the query;
determining a plurality of document embedding score values for the plurality of document embeddings of each document segment among the plurality of document segments based on the query embedding; and
re-training the machine-learning model further based on the plurality of document embedding score values for the plurality document embeddings of each document segment.

3. The computer-implemented method of claim 2, wherein the query comprises instructions expressing one or more of a theme, a query expansion, or a position side associated with the theme, the method further comprising:
generating the query embedding based on one or more of the theme, the query expansion, or the position side associated with the theme.

4. The computer-implemented method of claim 2, wherein the recommended asset portfolio comprises asset identifier values corresponding to one or more assets, the method further comprising:
determining asset score values for the one or more assets based on the document embedding score values;
ranking the one or more assets based on their respective asset score values; and
outputting an ordered list of the one or more assets based on the ranking.

5. The computer-implemented method of claim 4 further comprising:
re-training the machine-learning model further based on the asset score values for the one or more assets.

6. The computer-implemented method of claim 1, wherein the recommended asset portfolio comprises asset identifier values corresponding to one or more assets, each of the assets being associated with one or more of a weight, an asset type, one of the asset identifier values, an asset description, a theme, a theme relevancy score, a factor, or a factor value.

7. The computer-implemented method of claim 1 further comprising:
repeating the re-training of the machine-learning model continuously based on a specified frequency or timing.

8. The computer-implemented method of claim 1, wherein each document of the set of documents is associated with a timestamp that is after a threshold time, the method further comprising:
identifying the set of digitally stored documents based on their respective timestamps being after the threshold time.

9. The computer-implemented method of claim 1 further comprising:
determining a position side associated with the theme for each document segment; and
generating the document embeddings for the document segments of each document, the document embedding for each document segment further embedding the position side associated with the theme associated with that document segment.

10. One or more non-transitory computer-readable storage media storing one or more sequences of instructions which, when executed using one or more processors of a first computer, cause the one or more processors to execute:
receiving, from a second computer, a query specifying a request for a recommendation of an asset portfolio;
in response to receiving the query, identifying a set of digitally stored documents for use in re-training a trained machine-learning model capable of outputting a recommendation of a particular asset portfolio;
generating and storing in memory of the first computer a plurality of document segments for each document of the set of documents;
determining at least a theme and a theme-specific summary for each document segment among the plurality of document segments;
generating a plurality of document embeddings for the plurality of document segments of each document of the set of documents, the document embedding for each document segment embedding the theme, and the theme-specific summary associated with that document segment;
re-training the trained machine-learning model based on the document embeddings to produce a re-trained machine-learning model; and
executing an inference stage of the re-trained machine-learning model over the query to cause outputting a recommended asset portfolio.

11. The one or more non-transitory computer-readable storage media of claim 10 further comprising sequences of instructions which, when executed using the one or more processors, cause the one or more processors to execute:
generating a query embedding for the query;
determining a plurality of document embedding score values for the plurality of document embeddings of each document segment among the plurality of document segments based on the query embedding; and
re-training the machine-learning model further based on the plurality of document embedding score values for the plurality document embeddings of each document segment.

12. The one or more non-transitory computer-readable storage media of claim 11, wherein the query comprises instructions expressing one or more of a theme, a query expansion, or a position side associated with the theme, the one or more non-transitory computer-readable storage media further comprising sequences of instructions which, when executed using the one or more processors, cause the one or more processors to execute:
generating the query embedding based on one or more of the theme, the query expansion, or the position side associated with the theme.

13. The one or more non-transitory computer-readable storage media of claim 11, wherein the recommended asset portfolio comprises asset identifier values corresponding to one or more assets, the one or more non-transitory computer-readable storage media further comprising sequences of instructions which, when executed using the one or more processors, cause the one or more processors to execute:
determining asset score values for the one or more assets based on the document embedding score values;
ranking the one or more assets based on their respective asset score values; and
outputting an ordered list of the one or more assets based on the ranking.

14. The one or more non-transitory computer-readable storage media of claim 13 further comprising sequences of instructions which, when executed using the one or more processors, cause the one or more processors to execute:
re-training the machine-learning model further based on the asset score values for the one or more assets.

15. The one or more non-transitory computer-readable storage media of claim 10, wherein the recommended asset portfolio comprises asset identifier values corresponding to one or more assets, each of the assets being associated with one or more of a weight, an asset type, one of the asset identifier values, an asset description, a theme, a theme relevancy score, a factor, or a factor value.

16. The one or more non-transitory computer-readable storage media of claim 10 further comprising sequences of instructions which, when executed using the one or more processors, cause the one or more processors to execute:
repeating the re-training of the machine-learning model continuously based on a specified frequency or timing.

17. The one or more non-transitory computer-readable storage media of claim 14, wherein each document of the set of documents is associated with a timestamp that is after a threshold time, the one or more non-transitory computer-readable storage media further comprising sequences of instructions which, when executed using the one or more processors, cause the one or more processors to execute:
identifying the set of digitally stored documents based on their respective timestamps being after the threshold time.

18. The one or more non-transitory computer-readable storage media of claim 10 further comprising sequences of instructions which, when executed using the one or more processors, cause the one or more processors to execute:
determining a position side associated with the theme for each document segment; and
generating the document embeddings for the document segments of each document, the document embedding for each document segment further embedding the position side associated with the theme associated with that document segment.

19. A computer system, comprising:
one or more central processing units;
one or more network interfaces that are configured to communicatively couple the one or more central processing units to a data communication network; and
electronic digital random access memory storing a plurality of sequences of stored program instructions which, when executed by the one or more central processing units, cause the one or more central processing units to execute:
receiving, from a computer, a query specifying a request for a recommendation of an asset portfolio;
in response to receiving the query, identifying a set of digitally stored documents for use in re-training a trained machine-learning model capable of outputting a recommendation of a particular asset portfolio;
generating and storing in the electronic digital random access memory a plurality of document segments for each document of the set of documents;
determining at least a theme and a theme-specific summary for each document segment among the plurality of document segments;
generating a plurality of document embeddings for the plurality of document segments of each document of the set of documents, the document embedding for each document segment embedding the theme, and the theme-specific summary associated with that document segment;
re-training the trained machine-learning model based on the document embeddings to produce a re-trained machine-learning model; and
executing an inference stage of the re-trained machine-learning model over the query to cause outputting a recommended asset portfolio.

20. The computer system of claim 19, the sequences of stored program instructions, when executed by the one or more central processing units, further causing the one or more central processing units to execute:
generating a query embedding for the query;
determining a plurality of document embedding score values for the plurality of document embeddings of each document segment among the plurality of document segments based on the query embedding; and
re-training the machine-learning model further based on the plurality of document embedding score values for the plurality document embeddings of each document segment.
